(19) United States
(12) Patent Application Publication
(10) Pub. No.: US 2025/0247880 A1
(43) Pub. Date: Jul. 31, 2025

(54) METHOD AND APPARATUS FOR SIDELINK CHANNEL ACCESS

(71) Applicant: ZTE CORPORATION, Shenzhen (CN)

(72) Inventors: Yuzhou HU, Shenzhen (CN); Weimin XING, Shenzhen (CN); Youxiong LU, Shenzhen (CN); Jie CHEN, Shenzhen (CN)

(73) Assignee: ZTE CORPORATION, Shenzhen (CN)

(21) Appl. No.: 18/985,969

(22) Filed: Dec. 18, 2024

Related U.S. Application Data
(63) Continuation of application No. PCT/CN2022/105572, filed on Jul. 13, 2022.

(51) Int. Cl. H04W 74/02; H04L 1/1812; H04L 27/26; H04W 72/25

(52) U.S. Cl. CPC H04W 74/02; H04L 1/1812; H04L 27/2678; H04W 72/25

(57) ABSTRACT

A wireless communication method for use in a wireless terminal is disclosed. The method comprises performing a second channel access procedure for a second transmission which is after a first transmission by using a first channel access procedure for the first transmission.

### CROSS-REFERENCE TO RELATED PATENT APPLICATIONS

This application is a Continuation of PCT Application No. PCT/CN2022/105572, filed Jul. 13, 2022, incorporated herein by reference in its entirety.

### TECHNICAL FIELD

This document is directed generally to wireless communications, and in particular to sidelink (SL) communications.

### BACKGROUND

To perform a transmission via a type I channel access procedure, it is expected that a SL user equipment (UE) shall follow a sensing timeline as shown in FIG. 1. Specifically, a counter N determines an overall sensing window, i.e., a time duration spanned by sensing slots, that need to be sensed, to be idle prior to transmissions and that is initialized to an initiation value Ni.

### SUMMARY

Depending on the actual situation of the sensing process, the UE may end up sensing during a longer window than the one determined by Ni due to, e.g., some sensed busy slots in a given defer duration Td. The overall sensing window is denoted as Nf shown in FIG. 1.

The UE-to-UE channel occupancy time (COT) sharing is supported in new radio (NR) SL in a shared channel and is expected to be supported at least in a dynamic channel access. Therefore, the type 1 channel access procedure may need to be specified for supporting the UE-to-UE sharing COT.

This document relates to methods, systems, and devices for SL and/or Uu interface (i.e., a Radio interface between a base station (e.g. gNB or a radio access network (RAN) node) and the UE) transmissions (including uplink and/or downlink transmissions), and in particular to methods, systems, and devices for channel access procedures of the SL and/or Uu interface transmissions.

The present disclosure relates to a wireless communication method for use in a wireless terminal. The method comprises performing a second channel access procedure for a second transmission which is after a first transmission by using a first channel access procedure for the first transmission.

Various embodiments may preferably implement the following features:

Preferably or in some embodiments, a value of a counter associated with a sensing time window for the first channel access procedure is decrementing or holds on.

Preferably or in some embodiments, using the first channel access procedure for a second transmission comprises: using a value of a counter associated with a sensing time window for the first channel access procedure to perform the second channel access procedure for the second transmission.

Preferably or in some embodiments, the channel access procedure is a type I channel access procedure.

Preferably or in some embodiments, the first transmission and the second transmission carry the same transport block or different transport blocks.

Preferably or in some embodiments, the first transmission and the second transmission are associated with the same or different hybrid automatic repeat request, HARQ, process identities.

Preferably or in some embodiments, the first transmission and the second transmission cannot share a channel occupancy time, COT.

Preferably or in some embodiments, an interval between two contiguous time resources reserved for the first transmission and the second transmission is greater than a threshold.

Preferably or in some embodiments, a cyclic prefix extension is disabled for the first transmission and the second transmission.

Preferably or in some embodiments, the first transmission and the second transmission are sidelink transmissions.

Preferably or in some embodiments, the sidelink transmissions are over an unlicensed spectrum.

Preferably or in some embodiments, the first transmission is one of an uplink transmission or a sidelink transmission over an unlicensed spectrum and the second transmission is another one of the uplink transmission or the sidelink transmission over the unlicensed spectrum.

Preferably or in some embodiments, a first priority value of the first transmission is greater than a second priority value of the second transmission.

Preferably or in some embodiments, the priority value or the prioritization is associated with a channel access priority class.

Preferably or in some embodiments, a prioritization between the first transmission and the second transmission is performed no earlier than a duration before an initiation of the first or second channel access procedure.

Preferably or in some embodiments, the second channel access procedure of the second transmission is initiated after the first channel access procedure is initiated and/or an associated grant of the second transmission is received after an associated grant of the first transmission is received.

Preferably or in some embodiments, the first channel access procedure of the first transmission is initiated and has not ended before an initiation of the second channel access procedures of the second transmission.

Preferably or in some embodiments, the wireless communication method further comprises transmitting, to a wireless network node, COT sharing information indicating that a COT sharing is unavailable.

Preferably or in some embodiments, an energy detection threshold for a COT sharing is provided and the COT sharing information indicates a row index which is corresponding to a parameter list associated with the COT sharing and indicates that the COT sharing is unavailable.

Preferably or in some embodiments, an energy detection threshold for a COT sharing is not provided and the COT sharing information indicates 0.

Preferably or in some embodiments, a channel occupancy time of the second transmission is one of:
a first COT determined based on a first priority value of a first transport block associated with the first transmission,
a second COT determined based on a second priority value of a second transport block associated with the second transmission, or
a third COT determined based on the maximum priority value or the minimum priority value within the first priority value of the first transport block associated with the first transmission and the second priority value of the second transport block associated with the second transmission.

The present disclosure relates to a wireless communication method for use in a wireless network node. The method comprises receiving, from a wireless terminal, channel occupancy time (COT) sharing information indicating that a COT sharing is unavailable.

Various embodiments may preferably implement the following features:

Preferably or in some embodiments, an energy detection threshold for a COT sharing is provided to the wireless terminal, and the COT sharing information indicates a row index which is corresponding to a parameter list associated with the COT sharing and indicates that the COT sharing is unavailable.

Preferably or in some embodiments, an energy detection threshold for a COT sharing is not provided to the wireless terminal, and the COT sharing information indicates 0.

The present disclosure relates to a wireless communication method for use in a wireless terminal. The method comprises performing a first channel access procedure for a first transmission, wherein a second channel access procedure of a second transmission after the first transmission is initiated after the first channel access procedure is initiated and/or an associated grant of the second transmission is received after an associated grant of the first transmission is received.

Various embodiments may preferably implement the following features:

Preferably or in some embodiments, the channel access procedure is a type I channel access procedure.

Preferably or in some embodiments, a first priority value of the first transmission is lower than a second priority value of the second transmission which is after the first transmission.

Preferably or in some embodiments, the priority value is associated with a channel access priority class.

Preferably or in some embodiments, a prioritization between the first transmission and the second transmission is performed no earlier than a duration T before an initiation of the first or second channel access procedure.

Preferably or in some embodiments, the first transmission and the second transmission are associated with the same or different hybrid automatic repeat request, HARQ, process identities.

Preferably or in some embodiments, the first transmission and the second transmission carry the same transport block or different transport blocks.

Preferably or in some embodiments, the first transmission and the second transmission are sidelink transmissions.

Preferably or in some embodiments, the sidelink transmissions are over an unlicensed spectrum.

Preferably or in some embodiments, the first transmission is one of an uplink transmission or a sidelink transmission over an unlicensed spectrum and the second transmission is another one of the uplink transmission or the sidelink transmission over the unlicensed spectrum.

Preferably or in some embodiments, the first channel access procedure of the first transmission is initiated and has not ended before an initiation of the second channel access procedures of the second transmission.

Preferably or in some embodiments, the second channel access procedure of the second transmission is terminated.

Preferably or in some embodiments, the wireless communication method further comprises initiating the second channel access procedure for the second transmission.

The present disclosure relates to a wireless communication method for use in a wireless terminal. The method comprises performing a channel access procedure for a prioritized transmission having a lower priority value within a first transmission and a second transmission, wherein the channel access procedure is performed based on at least one channel access parameter of the prioritized transmission.

Various embodiments may preferably implement the following features:

Preferably or in some embodiments, the channel access procedure is a type I channel access procedure.

Preferably or in some embodiments, the at least one channel access parameter comprises a priority value of the prioritized transmission.

Preferably or in some embodiments, the priority value is associated with a channel access priority class.

Preferably or in some embodiments, the first transmission is one of an uplink transmission or a sidelink transmission over an unlicensed spectrum and the second transmission is another one of the uplink transmission or the sidelink transmission over the unlicensed spectrum.

Preferably or in some embodiments, the first transmission and the second transmission are sidelink transmissions.

Preferably or in some embodiments, the sidelink transmission are over an unlicensed spectrum.

Preferably or in some embodiments, the channel access procedure of the first transmission is initiated and not ended before an initiation of the channel access procedures of the second transmission.

The present disclosure relates to a wireless terminal. The wireless terminal comprises:
a communication unit, and
a processor configured to perform a second channel access procedure for a second transmission which is after a first transmission by using a first channel access procedure for the first transmission.

Various embodiments may preferably implement the following feature:

Preferably or in some embodiments, the processor is further configured to perform any of the aforementioned wireless communication methods.

The present disclosure relates to a wireless network node. The wireless network node comprises a communication unit, configured to receive, from a wireless terminal, channel occupancy time (COT) sharing information indicating that a COT sharing is unavailable.

Various embodiments may preferably implement the following feature:

Preferably or in some embodiments, the wireless network node further comprises a processor configured to perform any of the aforementioned wireless communication methods.

The present disclosure relates to a wireless terminal. The wireless terminal comprises:
a communication unit, and
a processor, configured to perform a first channel access procedure for a first transmission, wherein a second channel access procedure of a second transmission after the first transmission is initiated after the first channel access procedure is initiated and/or an associated grant of the second transmission is received after an associated grant of the first transmission is received.

Various embodiments may preferably implement the following feature:

Preferably or in some embodiments, the processor is further configured to perform any of the aforementioned wireless communication methods.

The present disclosure relates to a wireless terminal The wireless terminal comprises:
a communication unit, and
a processor, configured to perform a channel access procedure for a prioritized transmission having a lower priority value within a first transmission and a second transmission, wherein the channel access procedure is performed based on at least one channel access parameter of the prioritized transmission.

Various embodiments may preferably implement the following feature:

Preferably or in some embodiments, the processor is further configured to perform any of the aforementioned wireless communication methods.

The present disclosure relates to a computer program product comprising a computer-readable program medium code stored thereupon, the code, when executed by a processor, causing the processor to implement a wireless communication method recited in any one of the foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a sensing window.

FIG. 2 shows a schematic diagram of a network (architecture) according to an embodiment of the present disclosure.

FIG. 3 shows an example of a schematic diagram of a wireless terminal according to an embodiment of the present disclosure.

FIG. 4 shows an example of a schematic diagram of a wireless network node according to an embodiment of the present disclosure.

FIGS. 5 to 8 show flowcharts of methods according to embodiments of the present disclosure.

### DETAILED DESCRIPTION

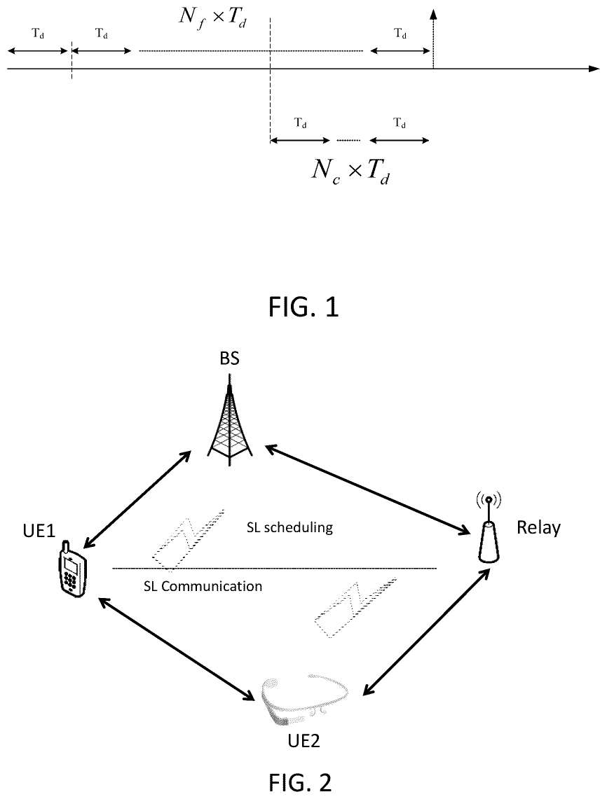

FIG. 2 shows a schematic diagram of a network (architecture) according to an embodiment of the present disclosure. The network shown in FIG. 1 comprises a base station (BS), a relay (node) (e.g., a header UE) and two UEs UE1 and UE2. For example, the UE1 may be a mobile phone and the UE2 may be a smart gadget (e.g., smart glasses). As an alternative, the UE1 and/or UE2 may be an internet of things (IoT) device. The UE1 and/or UE2 may communicate with the BS directly or via relay. Based on a SL scheduling received from the BS, the relay, UE1 and UE2 may communicate with each other, where the communication between every two of the relay, UE1 and UE2 are called SL communications. The SL communication may be in the form of unicast, groupcast or broadcast. Furthermore, the UE2 may communicate with the BS/relay via the UE1. That is the UE1 may act as a UE/mobile relay.

For the SL operations over an unlicensed spectrum, it is expected that a single SL control information (SCI) format 1-A reserves time and frequency resources for up to MaxNumPerReserve physical SL shared channel (PSSCH) transmissions, wherein MaxNumPerReserve is a value up to 3. The MaxNumPerReserve PSSCH transmissions may be associated with the same hybrid automatic repeat request (HARQ) process identity and/or carry the same transport block (TB). Note that MaxNumPerReserve may vary for different cases. When a type I channel access procedure is initiated for the first PSSCH transmission opportunity and the reserved resources are not equipped with a cyclic prefix extension (CPE) and/or are not back-to-back in time, follow-up/subsequent PSSCH transmission opportunities cannot share the COT initiated by the initiated type I channel access procedure for the first PSSCH transmission opportunity. Note that, in the present disclosure, the (time/frequency) resources being not back-to-back (in time) refers to that an interval between two contiguous resources are greater than a threshold (e.g., 16 or 25 microseconds). Under such conditions, a dedicated (type I) channel access procedure may need to be specified for a given follow-up PSSCH transmission. Thus, relevant rules and mechanism need to be specified to guarantee the successful transmission of the MaxNumPerReserve PSSCHs.

In addition, relevant rules and mechanisms may need to be specified to guarantee the PSSCH transmissions of (different) TBs which may occupy different HARQ processes to be successful.

In an embodiment, an NR transmission and an SL transmission over the unlicensed spectrum may be granted to be overlapped in time and either one or both of the NR and SL transmissions need to conduct the type I channel access procedure. That is relevant rules or mechanism needs to be specified for, e.g., the case of one of uplink (UL) and SL transmissions takes place based on prioritizations of the transmissions and another case of both UL and SL transmissions take place regardless of the priority of each transmission. Note that the rules and mechanism in relevant embodiments need to avoid impacting other NR Unlicensed (NR-U) operations, e.g., NR-U downlink (DL) operations.

In some embodiments, the PSSCH transmissions associated with the same HARQ process identity and/or carrying the same TB cannot share a same COT. For example, the transmission resources reserved by a SCI (format) 1-A are not back-to-back and/or the CPE is not enabled or disabled. In this embodiment, a follow-up (PSSCH) transmission of a previous (PSSCH) transmission associated with the same HARQ process identity and/or carrying the same transport block (and/or reserved in the same SCI 1-A) may perform a type I channel access procedure by:
using the ongoing/existing type I channel access procedure for the previous (PSSCH) transmission reserved in the same SCI 1-A.

In an embodiment, using the ongoing/existing type I channel access procedure refers to decrementing a counter N (associated with the sensing time window) from an Nc value of the ongoing/existing type I channel access procedure instead of initiating the counter N from an initiation value Ni. For example, the UE may initiate a (type I) channel access procedure for a transmission and starts a counter N from the initiation value Ni. Based on sensed results in each defer duration Td, the value of the counter N may be decremented to (ongoing) and/or hold on to (existing) an Nc value when the UE (needs to) initiates another (type I) channel access procedure for a subsequent transmission. In this example, the UE may initiate the channel access procedure for the subsequent transmission by initiating a counter N from the Nc value (i.e., using the ongoing/existing (type I) channel access procedure).

In an embodiment, the ongoing type I channel access procedure represents that the value of the counter N in the type I channel access procedure is still decrementing (e.g., the counter N is still counting).

In an embodiment, the existing type I channel access procedure means that the value of the counter N in the type I channel access procedure holds on (e.g., the counter N stops counting).

In some embodiments, for the type I channel access procedures before the transmissions of (the same or different) TBs which may occupy different HARQ processes (e.g., have the same or different HARQ identities), the type I channel access procedure for a transmission of a first TB may:
use the ongoing/existing type I channel access procedure for another second TB if a priority value of the transmission of the first TB is the same or smaller than the priority value of the transmission of the second TB, and/or
initiate a new type I channel access procedure and not terminate the ongoing/existing type I channel access procedure for a transmission of another second TB if the transmission of the first TB is larger than the priority value of the transmission of the second TB given that the transmissions are quite independent from each other, and/or
initiate a new type I channel access procedure.

Note that the priority value may be a channel access priority class or a value associated with the channel access priority class. In the present disclosure, the transmission has a higher priority if having a smaller priority value. In other words, if a first priority value of a first transmission is smaller than a second priority value of a second transmission, the first transmission is prioritized over the second transmission or the first transmission has a higher priority than the second transmission.

For the aforementioned embodiments, the channel access procedure for the transmission of the second TB is initiated before the channel access procedure for the transmission of the first TB is initiated and/or an associated grant for the transmission of the second TB is received before an associated grant for the transmission of the first TB is received. The prioritization between the transmission of the first TB and the transmission of the second TB is performed/determined no earlier than a duration before an initiation of the first or second channel access procedure.

In some embodiments, the NR transmission (e.g., UL transmission) and the SL transmission (over the unlicensed spectrum) may overlap in time and both the NR transmission and the SL transmission need to perform the type I channel access procedure. Under such a condition, the type I channel access procedure for one of the NR transmission and the SL transmission may not be completed before the type I channel access procedure for one of the NR transmission and the SL transmission is initiated. In these embodiments, the type I channel access procedure may be supposed to take place in case a prioritization procedure of determining a prioritized transmission from the NR transmission and the SL transmission is performed either after or not at least a duration of T before the type I channel access procedure for either one of the NR transmission and the SL transmission, such that there is no sufficient time to determine a prioritized transmission from the NR transmission and the SL transmission.

In an embodiment, when both the NR transmission and the SL transmission (over the unlicensed spectrum) need to conduct the type I channel access procedure, only one of the SL transmission or the NR transmission is determined to be transmitted as a result of certain prioritization rules:
in case the (UL or SL) transmission whose channel access procedure initiated or associated grant received latter in time is prioritized and will be transmitted, the type I channel access procedure for the prioritized transmission shall use the ongoing/existing type I channel access procedure of the previous (SL or UL) transmission in time, and/or
in case the (UL or SL) transmission whose channel access procedure initiated or associated grant received earlier in time is prioritized, the type I channel access procedure of the prioritized transmission is maintained till the final transmission of the prioritized transmission, and/or
in case the (UL or SL) transmission whose channel access procedure initiated or associated grant received earlier in time is prioritized, the type I channel access procedure of the prioritized transmission is maintained till the final transmission of the prioritized transmission and the type I channel access procedure of the (UL or SL) transmission whose channel access procedure initiated or associated grant received latter in time is terminated.

In an embodiment, the type I channel access procedure is supposed to take place in case the prioritization is performed at least at a duration of T (e.g., 4 ms, 5 ms, 6 ms) before the channel access procedure of at least one of (e.g. either one of or both of) the SL or UL transmission such that there is sufficient time to determine a prioritized transmission between the SL transmission and the UL transmission and whose type I channel access procedure need to be performed. In this embodiment, when only one of the SL transmission and UL transmission is transmitted, the relevant type I channel access procedure may be performed after determining a prioritized transmission:
the type I channel access procedure follows the parameters of the prioritized transmission between the SL transmission and the UL transmission.

In an embodiment, both the UL transmission and the SL transmission take place (e.g., at the same slot) regardless of the priority of each transmission. In this embodiment, the type I channel access procedures may be performed according to at least one of:
the later transmission in time within the UL transmission and SL transmission uses the ongoing/existing type I channel access procedure corresponding to the earlier transmission in time if the later transmission has a priority value being the same or smaller than a priority value of the earlier transmission, and/or
the later transmission in time within the UL transmission and SL transmission uses the ongoing/existing type I channel access procedure to initiate a new type I channel access procedure for the earlier transmission within the UL transmission and SL transmission and the ongoing/existing type I channel access procedure is not terminated (i.e. is maintained) if a priority value of the later transmission is larger than that of the earlier transmission in time (given that the transmissions are quite independent from each other).

In an embodiment, a transmission being later in time than another transmission refers to/includes at least one of:
the transmission takes place later in time than another transmission,
the channel access procedure of the transmission is initiated later in time than the channel access procedure of another transmission, or
the associated grant for the transmission is received later in time than the associated grant for another transmission.

In some embodiments of a transmission using the ongoing/existing type I channel access procedure for another transmission, the UE may indicate, to the BS via UL control information (UCI), that the COT is not available. Depending on whether the higher layer parameter ul-toDL-COT-SharingED-Threshold-r16 is provided or not, the following indication rules need to be specified:
If the higher layer parameter ul-toDL-COT-SharingED-Threshold-r16 is provided, the UE is configured by a higher layer parameter cg-COT-SharingList-r16 where the higher layer parameter cg-COT-SharingList-r16 provides a table configured by the higher layer. Each row of the table provides a channel occupancy sharing information given by a higher layer parameter CG-COT-Sharing-r16. One row of the table is configured for indicating that the channel occupancy sharing is not available. For example, the ‘COT sharing information’ in the CG-UCI detected in a slot n may indicate a row index corresponding to the higher layer parameter CG-COT-Sharing-r16 which indicates that the channel occupancy sharing is not available,
If the higher layer parameter ul-toDL-COT-SharingED-Threshold-r16 is not provided, the ‘COT sharing information’ in CG-UCI indicates ‘0’.

Note that the higher layer parameter ul-toDL-COT-SharingED-Threshold-r16 is associated with an energy detection threshold for the COT sharing. For example, the higher layer parameter ul-toDL-COT-SharingED-Threshold-r16 is provided refers to that the energy detection threshold for the COT sharing is provided. The higher layer parameter ul-toDL-COT-SharingED-Threshold-r16 is not provided means that the energy detection threshold for the COT sharing is not provided.

In some embodiments, when the type I channel access procedure for the transmission of a TB uses an ongoing/existing type I channel access procedure, the (remaining) channel occupancy time shall be at least one of the following:
the channel occupancy time determined by the priority of the TB itself,
the channel occupancy time determined by the TB whose ongoing/existing type I channel access procedure is used, or
the channel occupancy time determined by the maximum or the minimum of the TB itself or the TB whose ongoing/existing type I channel access procedure is used.

Note that the aforementioned priority (value) may be either a priority value of the TB or a channel value priority class value.

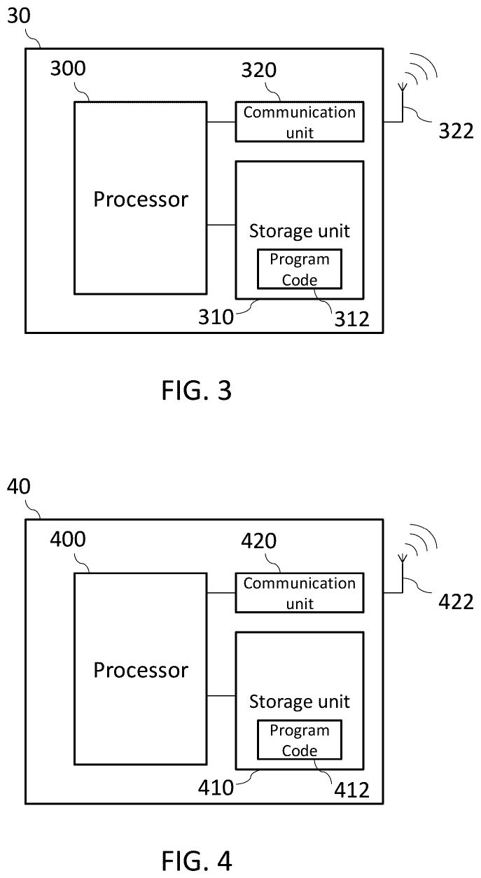

FIG. 3 relates to a schematic diagram of a wireless terminal 30 according to an embodiment of the present disclosure. The wireless terminal 30 may be a user equipment (UE), a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 310 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g., a base station).

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 40 may comprise (perform) at least one network function such as an access and mobility management function (AMF), a session management function (SMF), a user place function (UPF), a policy control function (PCF), an application function (AF), etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 410 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g., a user equipment or another wireless network node).

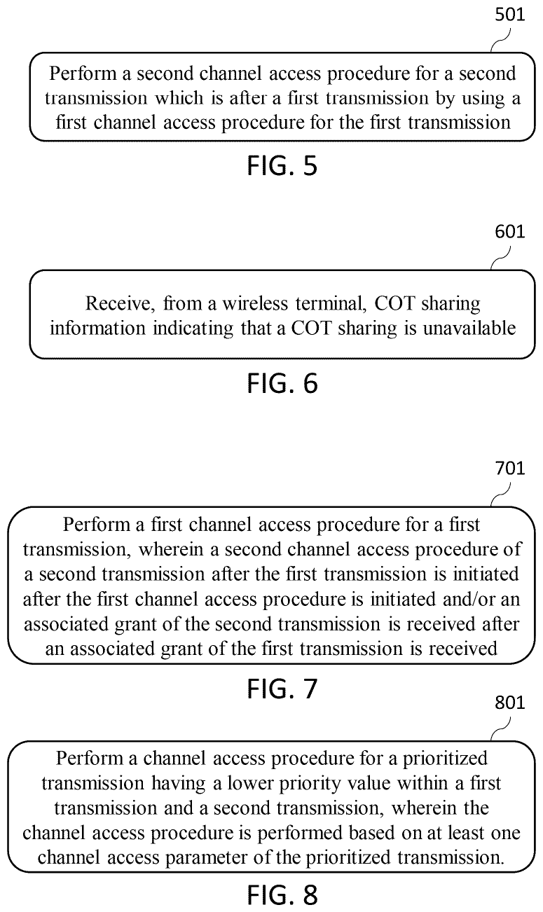

FIG. 5 shows a flowchart of a method according to an embodiment of the present disclosure. The method shown in FIG. 5 may be used in a wireless terminal (e.g., UE) and comprises the following step:

Step 501: Perform a second channel access procedure for a second transmission which is after a first transmission by using a first channel access procedure for the first transmission.

In FIG. 5, a second transmission is (configured to be) after a first transmission and a second channel access procedure for the second transmission is performed by using a first channel access procedure for the first transmission. Specifically, the wireless terminal may need to perform the first channel access procedure for the first transmission and perform the second channel access procedure for the second transmission which is (configured to be initiated) after the first transmission. Under such conditions, the first channel access procedure may not end before the second channel access procedure is initiated. In this embodiment, the wireless terminal performs the second channel access procedure by using the first channel access procedure, to guarantee that the second transmission can be successfully performed.

In an embodiment, a value of a counter associated with a sensing time window for the first channel access procedure is decrementing or holds on. That is the first channel access procedure is still on-going or existing or has not ended.

In an embodiment, using the first channel access procedure for a second transmission refers to using a value of a counter associated with a sensing time window for the first channel access procedure to perform the second channel access procedure for the second transmission. For example, the wireless terminal may use the value of the counter for the on-going/existing first channel access procedure as an initiation value of the counter associated with the sensing time window for the second channel access procedure.

In an embodiment, the first/second channel access procedure is the type I channel access procedure.

In an embodiment, the first transmission and the second transmission carry the same TB or different TBs.

In an embodiment, the first transmission and the second transmission are associated with the same or different HARQ process identities (IDs).

In an embodiment, the first transmission and the second transmission cannot share a COT.

In an embodiment, an interval between two contiguous time resources reserved for the first transmission and the second transmission is greater than a threshold and/or a CPE is disabled for the first transmission and the second transmission.

In an embodiment, the first transmission and the second transmission are SL transmissions. Note that the SL transmissions may be over an unlicensed spectrum.

In an embodiment, the first transmission is one of a UL transmission or a SL transmission over an unlicensed spectrum and the second transmission is another one of the UL transmission or the SL transmission over the unlicensed spectrum.

In an embodiment, a first priority value of the first transmission is greater than a second priority value of the second transmission. Note that, in the present disclosure, a greater priority value refers to a lower priority. In other words, the priority of first transmission is lower than that of the second transmission in this embodiment.

In an embodiment, a prioritization (procedure) between the first transmission and the second transmission is performed no earlier than a duration before an initiation of the first or second channel access procedure. In this embodiment, the wireless terminal does not acknowledge the priority sequence of the first transmission and the second transmission before initiating the first or second channel access procedure.

In an embodiment, the priority value is associated with a channel access priority class.

In an embodiment, the second channel access procedure of the second transmission is (configured to be) initiated after the first channel access procedure is initiated.

In an embodiment, the wireless terminal receives an associated grant of the second transmission after receiving an associated grant of the first transmission.

In an embodiment, the first channel access procedure of the first transmission is initiated and has not ended before an initiation of the second channel access procedures of the second transmission.

In an embodiment, the wireless terminal transmits COT sharing information indicating that a COT sharing is unavailable to a wireless network node. The COT sharing information may be transmitted in UCI.

In an embodiment, an energy detection threshold for a COT sharing (e.g., higher layer parameter ul-toDL-COT-SharingED-Threshold-r16) is provided to the wireless terminal. In this embodiment, the COT sharing information indicates a row index which is corresponding to a parameter list associated with the COT sharing and indicates that the COT sharing is unavailable.

In an embodiment, an energy detection threshold for a COT sharing (e.g., higher layer parameter ul-toDL-COT-SharingED-Threshold-r16) is not provided to the wireless terminal. In this embodiment, the COT sharing information indicates a bit (value) ‘0’.

In an embodiment, a (remaining) COT of the second transmission is a first COT determined based on a first priority value of a first transport block associated with the first transmission.

In an embodiment, a (remaining) COT of the second transmission is a second COT determined based on a second priority value of a second transport block associated with the second transmission.

In an embodiment, a (remaining) COT of the second transmission is a third COT determined based on the maximum priority value or the minimum priority value within the first priority value of the first transport block associated with the first transmission and the second priority value of the second transport block associated with the second transmission.

FIG. 6 shows a flowchart of a method according to an embodiment of the present disclosure. The method shown in FIG. 6 may be used in a wireless network node and comprises the following step:

Step 601: Receive, from a wireless terminal, COT sharing information indicating that a COT sharing is unavailable.

In this embodiment, the wireless network node receives COT sharing information from a wireless terminal (e.g., UE). The received COT sharing information indicates that a COT sharing is unavailable, for transmissions from the wireless terminal.

In an embodiment, an energy detection threshold for a COT sharing is provided to the wireless terminal. In this embodiment, the COT sharing information indicates a row index which is corresponding to a parameter list associated with the COT sharing and indicates that the COT sharing is unavailable.

In an embodiment, an energy detection threshold for a COT sharing is not provided to the wireless terminal. In this embodiment, the COT sharing information indicates a bit (value) ‘0’.

FIG. 7 shows a flowchart of a method according to an embodiment of the present disclosure.

Step 701: Perform a first channel access procedure for a first transmission, wherein a second channel access procedure of a second transmission after the first transmission is initiated after the first channel access procedure is initiated and/or an associated grant of the second transmission is received after an associated grant of the first transmission is received.

In FIG. 7, the wireless terminal performs a first channel access procedure for a first transmission. In this embodiment, a second channel access procedure for a second transmission, which is (configured to be) after the first transmission, is (configured to be) initiated after the initiation of the first channel access procedure or after the first channel access procedure is initiated. As an alternative or in addition, an associated grant of the second transmission is received after an associated grant of the first transmission is received. In this embodiment, the first channel access procedure is maintained or keeps running or is not terminated.

In an embodiment, the channel access procedure is a type I channel access procedure.

In an embodiment, a first priority value of the first transmission is lower than a second priority value of the second transmission which is after the first transmission. That is the first transmission is prioritized over or has a higher priority than the second transmission.

In an embodiment, the priority value is associated with a channel access priority class.

In an embodiment, a prioritization between the first transmission and the second transmission is performed no earlier than a duration T before an initiation of the first or second channel access procedure.

In an embodiment, the first transmission and the second transmission are associated with the same or different HARQ process IDs.

In an embodiment, the first transmission and the second transmission carry the same transport block or different transport blocks.

In an embodiment, the first transmission and the second transmission are SL transmissions (over an unlicensed spectrum).

In an embodiment, the first transmission is one of a UL transmission or an SL transmission over an unlicensed spectrum and the second transmission is another one of the UL transmission or the SL transmission over the unlicensed spectrum.

In an embodiment, the first channel access procedure of the first transmission is initiated and has not ended before an initiation of the second channel access procedures of the second transmission.

In an embodiment, the second channel access procedure of the second transmission is terminated.

In an embodiment, the wireless terminal initiates the second channel access procedure for the second transmission. That is the second channel access procedure is not terminated.

FIG. 8 shows a flowchart of a method according to an embodiment of the present disclosure. The method shown in FIG. 8 may be used in a wireless terminal (e.g., UE) and comprises the following step:

Step 801: Perform a channel access procedure for a prioritized transmission having a lower priority value within a first transmission and a second transmission, wherein the channel access procedure is performed based on at least one channel access parameter of the prioritized transmission.

In the embodiment shown in FIG. 8, the wireless terminal performs a channel access procedure for a prioritized transmission having a lower priority value within a first transmission and a second transmission. Note that having the lower priority value refers to having a higher priority. In this embodiment, the channel access procedure is performed based on at least one channel access parameter of the prioritized transmission.

In an embodiment, the channel access procedure is a type I channel access procedure.

In an embodiment, the priority value is associated with a channel access priority class.

In an embodiment, the at least one channel access parameter is/comprises a priority value of the prioritized transmission.

In an embodiment, the first transmission is one of a UL transmission or an SL transmission over an unlicensed spectrum and the second transmission is another one of the UL transmission or the SL transmission over the unlicensed spectrum.

In an embodiment, the first transmission and the second transmission are SL transmissions (over an unlicensed spectrum).

In an embodiment, the channel access procedure of the first transmission is initiated and not ended before an initiation of the channel access procedures of the second transmission. In this embodiment, the channel access procedure of the first transmission may be terminated or used by/for the second transmission if the second transmission has a higher priority than the first transmission.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method, comprising:
performing, by a wireless communication device, a first transmission by using a first channel access procedure,
performing, by the wireless communication device, a second channel access procedure for a second transmission which is after the first transmission by using the first channel access procedure and by using a value of a counter associated with a sensing time window for the first channel access procedure;
wherein the value of the counter is decrementing; and
wherein the channel access procedure is a type I channel access procedure.

2. The wireless communication method of claim 1, wherein the first transmission and the second transmission carry the same transport block or different transport blocks.

3. The wireless communication method of claim 1, wherein the first transmission and the second transmission are associated with the same or different hybrid automatic repeat request (HARQ) process identities.

4. The wireless communication method of claim 1, wherein
the first transmission and the second transmission cannot share a channel occupancy time (COT), and/or
an interval between two contiguous time resources reserved for the first transmission and the second transmission is greater than a threshold, and/or
a cyclic prefix extension is disabled for the first transmission and the second transmission.

5. The wireless communication method of claim 1, wherein the first transmission and the second transmission are sidelink transmissions.

6. The wireless communication method of claim 1, wherein the first transmission is one of an uplink transmission or a sidelink transmission over an unlicensed spectrum and the second transmission is another one of the uplink transmission or the sidelink transmission over the unlicensed spectrum.

7. The wireless communication method of claim 1, wherein a first priority value of the first transmission is greater than a second priority value of the second transmission.

8. The wireless communication method of claim 6, wherein the priority value is associated with a channel access priority class.

9. The wireless communication method of claim 1, wherein a prioritization between the first transmission and the second transmission is performed no earlier than a duration before an initiation of the first or second channel access procedure.

10. The wireless communication method of claim 1, wherein the second channel access procedure of the second transmission is initiated after the first channel access procedure is initiated and/or an associated grant of the second transmission is received after an associated grant of the first transmission is received.

11. The wireless communication method of claim 1, wherein the first channel access procedure of the first transmission is initiated and has not ended before an initiation of the second channel access procedures of the second transmission.

12. The wireless communication method of claim 1, further comprising:
transmitting, to a wireless network node, COT sharing information indicating that a COT sharing is unavailable.

13. The wireless communication method of claim 11, wherein an energy detection threshold for a COT sharing is provided, and
wherein the COT sharing information indicates a row index which is corresponding to a parameter list associated with the COT sharing and indicates that the COT sharing is unavailable.

14. The wireless communication method of claim 11, wherein an energy detection threshold for a COT sharing is not provided, and
wherein the COT sharing information indicates 0.

15. The wireless communication method of claim 1, wherein a channel occupancy time of the second transmission is one of:
a first COT determined based on a first priority value of a first transport block associated with the first transmission,
a second COT determined based on a second priority value of a second transport block associated with the second transmission, or
a third COT determined based on the maximum priority value or the minimum priority value within the first priority value of the first transport block associated with the first transmission and the second priority value of the second transport block associated with the second transmission.

16. A wireless communication device, comprising:
a communication unit, and
at least one processor, configured to:
perform a first transmission by using a first channel access procedure,
perform a second channel access procedure for a second transmission which is after the first transmission by using the first channel access procedure and by using a value of a counter associated with a sensing time window for the first channel access procedure;
wherein the value of the counter is decrementing; and
wherein the channel access procedure is a type I channel access procedure.

17. A non-transitory computer-readable program storage medium comprising code stored thereon, the code, when executed by at least one processor, causing the at least one processor to implement a method comprising:
performing a first transmission by using a first channel access procedure, performing a second channel access procedure for a second transmission which is after the first transmission by using the first channel access procedure and by using a value of a counter associated with a sensing time window for the first channel access procedure;
wherein the value of the counter is decrementing; and
wherein the channel access procedure is a type I channel access procedure.
